(19) United States
(12) Patent Application Publication
(10) Pub. No.: US 2022/0043639 A1
(43) Pub. Date: Feb. 10, 2022

(54) CONTROL OF MISSION DATA TOOL APPLICATION PROGRAM INTERFACES

(71) Applicant: BAE Systems Information and Electronic Systems Integration Inc., Nashua, NH (US)

(72) Inventors: Mark R. Jennings, New Milford, NJ (US); Jeffrey L. Neuman, New York, NY (US)

(73) Assignee: BAE Systems Information and Electronic Systems Integration Inc., Nashua, NH (US)

(21) Appl. No.: 17/275,843

(22) PCT Filed: Jun. 21, 2019
(86) PCT No.: PCT/US19/38414

§ 371 Date: Mar. 12, 2021

(51) Int. Cl. G06F 8/41; G06F 8/30; G06F 9/54

(52) U.S. Cl. CPC G06F 8/447; G06F 9/541; G06F 8/315

(57) ABSTRACT

The system and method for decoupling algorithms from a Mission Data Tool suite, or the like, into a scalable, modular and multithreaded tool set callable from a variety of environments. The system generates data objects representing inputs, outputs and field validation capable of being accessed from a framework callable from Java or C#, for example. Data objects are defined in an abstract Independent Definition Language (IDL) and the objects are then generated into the target languages for use by a software component's application programming interface (API). The resulting generated code may also contain serialization/deserialization routines needed for object transfer between different systems in a seamless manner. In some cases, transfer of the objects, algorithmic generation of data into the objects, and the transfer of outputs back to the calling system is possible with minimal overhead and interaction on either end.

### STATEMENT OF GOVERNMENT INTEREST

This disclosure was made with United States Government support under Contract No. H94003-04-D-0002 awarded by The United States Air Force. The United States Government has certain rights in this invention.

### FIELD OF THE DISCLOSURE

The present disclosure relates to object-oriented programming languages and more particularly to an object-oriented programming language for use with Electronic Warfare (EW) Mission Data Tools (MDT) using data objects in an abstract Independent Definition Language (IDL) for integration of generated data objects in disparate language implementations.

### BACKGROUND OF THE DISCLOSURE

The state of current software development varies on how best to implement and integrate objects between disparate languages that exchange object contents via an Application Program Interface (API). In computer programming, API is a set of subroutine definitions, communication protocols, and tools for building software. In general terms, it is a set of clearly defined methods of communication among various components that allows the components to communicate with each other. The components are typically software components or applications that may be on disparate platforms. Implementation issues typically arise around how best to handle objects in view of multiple attributes including data persistence, data exchange, serialization/deserialization, validation, security and documentation, and the like.

While off the shelf solutions exist to help alleviate some issues, these solutions tend to be generic, non-portable and development kit specific. Some industry standards aid in the exchange of objects performing a form of serialization/deserialization without regard for other issues such as data persistence, validation, documentation or security. This leads to a need to use multiple off the shelf software elements for the remaining attributes, which then confines the solution, and makes it more complex and more expensive.

Wherefore it is an object of the present disclosure to overcome the above-mentioned shortcomings and drawbacks associated with conventional object oriented approaches for integration of data objects between disparate language implementations.

### SUMMARY OF THE DISCLOSURE

One aspect of the present disclosure is a system comprising a method of integration of data objects between disparate language implementations, comprising: defining a plurality of data objects in an abstract Independent Definition Language (IDL); storing the plurality of data objects in memory; compiling, via an IDL compiler, a symbol table representing the plurality of data objects; generating target code for the plurality of data objects; generating the plurality of data objects into a target language; calling the plurality of data objects via an application programming interface from an application; validating the plurality of data objects to the application programming interface in memory; transferring the plurality of data objects to the application programming interface; and transferring output from the application programming interface to the application.

One embodiment of the method is wherein the generated code also contains serialization/deserialization routines needed for object transfer.

Another embodiment of the method is wherein generating target code for the plurality of data objects includes endianness and data type differences between languages without the need for development intervention. In some cases, generating target code for the plurality of data objects includes data storage specifications required by ORM, JSON or SQL. In one example the implementation is a flat file.

Yet another embodiment of the method further comprises generating target code for field validation is contained in the data objects. In certain embodiments, generating target code for the plurality of data objects includes transmission and documentation for use in an Interface Control Document (ICD).

Still yet another embodiment of the method is wherein defining a plurality of data objects includes names, types, security levels, access levels, tags for database composition, and field descriptions. In some cases, generating target code for the plurality of data objects includes support for abstraction and inheritance. In one embodiment serialization is executed in memory.

Another embodiment is wherein transferring can be memory to memory or over a network. In some cases, the method further comprises creating symbol tables in memory for use in code generation. In certain embodiments, code generation is output to persistent storage and further comprises executing via a complier and using the symbol table.

Another aspect of the present disclosure is a computer program product including one or more non-transitory machine-readable mediums encoding instructions that when executed by one or more processors cause a process to be carried out for integrating data objects, the process comprising: defining a plurality of data objects in an abstract Independent Definition Language (IDL); storing the plurality of data objects in memory; compiling, via an IDL compiler, a symbol table representing the plurality of data objects; generating target code for the plurality of data objects; generating the plurality of data objects into a target language; calling the plurality of data objects via an application programming interface from an application; validating the plurality of data objects to the application programming interface in memory; transferring the plurality of data objects to the application programming interface; and transferring output from the application programming interface to the application.

One embodiment of the computer program product is wherein the data objects are directed to programming languages comprising C++, and the target code is Java and C#.

Another embodiment of the computer program product is comprising integrating the data objects into an Object Relational Mapping (ORM).

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a diagrammatic view of one embodiment of the system of the present disclosure.

FIG. 2 shows another diagrammatic view of one embodiment of the system of the present disclosure.

FIG. 3 shows a flow chart of one embodiment of a method according to the principles of the present disclosure.

### DETAILED DESCRIPTION OF THE DISCLOSURE

Electronic warfare (EW) and Mission Data Tool (MDT) systems comprise electronic support measures and countermeasures hardware for various systems (e.g., aircraft). A prior MDT suite was developed using Microsoft Foundation Classes (MFC) in the 1990s. The task of designing/implementing a MDT tool suite that encompasses EW, as well as other mission functions commenced. To do this, the algorithms from the EW tool suite needed to be decoupled into a scalable, modular, and multithreaded tool set callable from a Java or C# environment, or the like. One embodiment of the system of the present disclosure generates data objects representing inputs and outputs capable of being accessed from a framework callable from Java or C#. There, data objects typically vary in language since the legacy algorithms are implemented using C++ and the more recent target development environment uses Java.

In one embodiment of the system of the present disclosure, data objects are defined in an abstract Independent Definition Language (IDL) and the objects are then generated into the target languages. An interface description language or interface definition language (IDL), is a specification language used to describe data a software component's application programming interface (API) consumes or produces. IDLs describe objects in a language-independent way, enabling communication between software components that do not share a language. For example, between those written in C++ and those written in Java or C#. IDLs offer a bridge between the two different systems.

In one embodiment of the system of the present disclosure, the generated code also contains serialization/deserialization routines needed for object transfer between the two systems in a seamless manner. In certain embodiments, the target framework facilitates the transfer of the objects, algorithmic generation of data into the objects, and the transfer of outputs back to the calling system. This all occurs with minimal overhead and interaction on either end.

In some cases, the generated code deals with endianness and data type differences between languages without the need for development intervention. Endianness refers to the sequential order in which bytes are arranged into larger numerical values when stored in memory or when transmitted over digital links. Endianness is of interest in computer science because there are two conflicting and incompatible formats used: words may be represented in big-endian or little-endian format, depending on whether bits or bytes or other components are ordered from the most significant bit (big end) or the least significant bit (little end).

In certain embodiments, the present system allows for integration of data objects into Object Relational Mapping (ORM) and is optimized for a multi-tier solution. ORM is a mechanism that makes it possible to address, access and manipulate objects without having to consider how those objects relate to their data sources. This creates, in effect, a “virtual object database” that can be used from within the programming language. Additionally, the solution is advanced in IDL definition by supporting advanced constructs and inheritance.

In one embodiment of the present disclosure, object code generation ties it all together (C++, C#, Java, etc.) An IDL compiler is used to generate target code for multiple languages/environments. This makes it possible to deal with objects in isolation within the target development environment. The code generation generates the object structure, serialization/deserialization routines, and validation functions, data storage specifications required by ORM, JSON or SQL. In one example the implementation is a flat file. In addition, the code generation produces code that handles endian conversion for transmission and documentation to be part of an ICD, or Interface Control Document. In certain embodiments, the IDL contains enough information to generate the object characteristics in an ICD. This is immensely valuable in reducing the staff required to support the system.

In one embodiment of the present disclosure, an Independent Definition Language (IDL) is used to define objects. The definition includes all that needs to be known about an object such as names, types, security levels, access levels (read-only versus read-write), tags for database composition, field descriptions, and the like. This is in one set of source located together and associated with declarations. In one embodiment, C/C++ like grammar is used. The grammar has a similar syntactical flavor to C/C++ and therefore is relatively easy for people to grasp and maintain.

Certain embodiments of the system of the present disclosure supports advanced concepts such as abstraction and inheritance. One of the design decisions was to support abstractions and inheritance in the code generation. The usage expectation is to allow easy integration into the target system maintaining advanced object oriented techniques. Otherwise, consideration of proxy objects translating from one form to another to support object oriented could defeat the purpose of the approach. In some embodiments, the system generates language specific syntax. Compilation of generated code in the target language can occur without modification. Trust of the generated code minimizes unit testing and developers can instead focus on business logic.

In one embodiment of the system of the present disclosure, the IDL syntax includes access level permissions for member fields. These access tags are used during code generation to produce gets/sets of all variables based on the access level. In some cases, the target code generated produces high quality and fast serialization/deserialization functions. Various generic approaches that do not know the information a priori rely on reflection or some other generic method to determine stream translation. These solutions tend to consume large amounts of memory and take substantially longer to produce. Code generation based on IDL knows the type and field information during IDL compilation and therefore can optimize the method.

One embodiment of the system of the present disclosure uses object size computation for fast buffering. Code generation produces simple calls to retrieve the complete object sizes required on the wire. There is a performance gain realized in knowing the size prior to serialization because only one memory allocation is required to serialize any object. Other systems repeatedly reallocate since they do not know the actual size, which causes memory fragmentation in the application. By avoiding memory reallocation, the penalty of memory trash collection for heap cleanup is no longer a problem. This leads to better application performance

In some cases, code generation hides type promotion from the developer so there is little need to know the underlying details. Promotion occurs to ensure target languages exchange compatible types. For example, Java does not support an unsigned byte (0-255), where other languages do. In that case, produced Java code supports an integer value that has a maximum value of 255. Serialization of promoted data types produces code that handles this case so no additional user code is required.

Typically, systems transmitting or receiving data over a network from disparate operating systems have to deal with representation differences of numerical and floating-point numbers. Some systems avoid the issue by transmitting in a common textual format which is industry accepted for smaller datasets. However, large sets with immediate needs may not be capable of meeting system requirements that way. Instead, translation of data from one form to the other occurs on one end of the exchange. The endianness problem is also not isolated just for network applications. Another example would be running a virtual machine that differs from the underlying operation environment. This occurs for example running a Java application on Intel hardware. Code generation eliminates hand coding of byte swapping for defined objects.

Many systems struggle with field validation (ranges, allowable values etc.) and tend to separate fields from their validation values. The IDL specification of the present disclosure contains field allowable attributes such that validation routines validate object contents. A Graphical User Interface (GUI) can then, for example, validate a field as the user enters the information without transmitting the object to the other end. Then, a service using the same object can check object validation criteria prior to algorithmic consumption. The IDL code of the present disclosure is rich in definitions such that documentation is available in the produced code. There, the code produced has tags so that development tools may use those tags to aid the developer when coding. In some cases, documentation also includes security marking of individual fields.

In some cases, ORM annotations are used to describe the hierarchy of the object composition. These annotations can either be passed to an ORM or used to code generate SQL type binding for data persistence.

Generation of target code to produce Java Script Object Notation (JSON) serialization formatted files or strings is possible in certain embodiments. This eliminates the need for a database for small applications. This is also a useful way to view the data in a text editor during debugging.

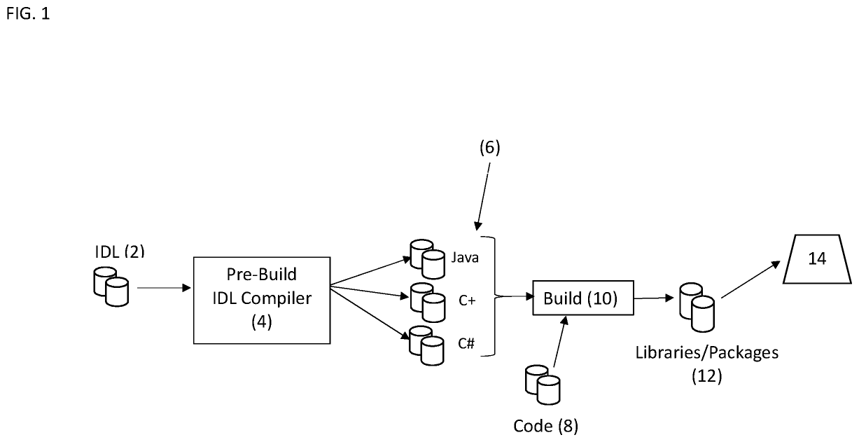

Referring to FIG. 1, a high-level view of one embodiment of the system of the present disclosure is shown. More specifically, the diagram shows an embodiment where IDL files 2 are sequentially read in by an IDL compiler 4, spanning folders if need be. In some cases, the IDL compiler 4 takes a first pass to build a symbol table containing the structure of all data objects and members including any informational context and a subsequent pass by the IDL compiler will use the symbol table to drive code generation and ultimately produce the target language files 6 to be included in and used by the target build environment 10. In 4, for example, Java generation will produce file extensions of .Java 6, C# generation will produce files having file extensions of .cs 6 and C++ code generation will produce files having file extensions of .h 6. In certain embodiments, the IDL compiler 4 is smart enough to avoid overwrite of existing file targets if they have not changed. Otherwise, the actual target compiler compiles all dependent code every time a build occurs. The target compiler and linkage assembler compile the generated code 10, which is organized into libraries/packages 12 to be later linked into a program executable 14. This adheres to accepted code development practices in modular programming styles. The result are executable programs 14 that have the ability to exchange data objects via an API with little development expertise required on the underlying mechanics, thus allowing the development staff to focus on maintaining/improving the application business logic.

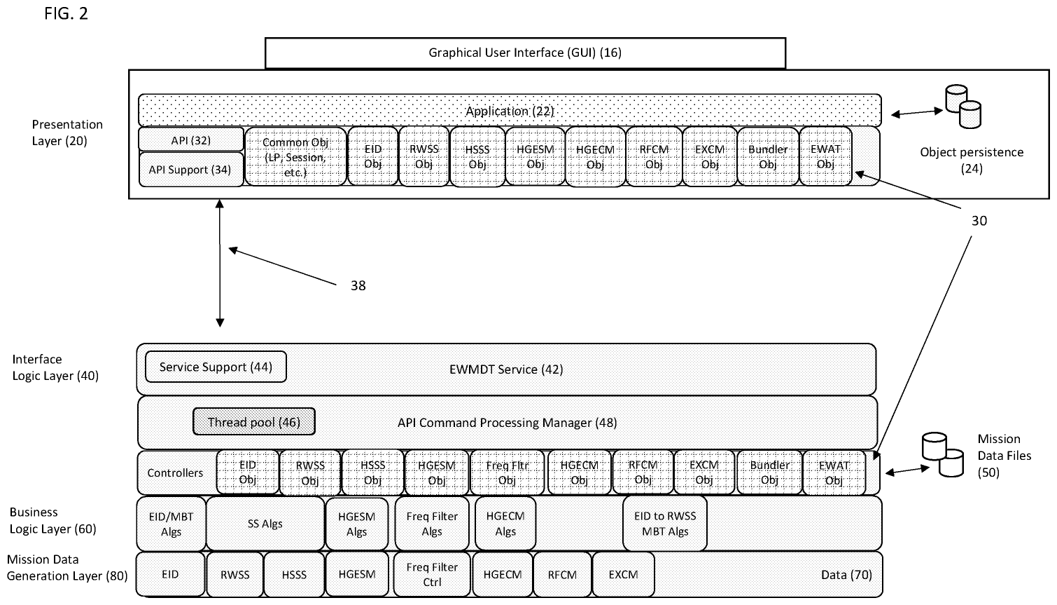

Referring to FIG. 2, a high-level view of one embodiment of the system of the present disclosure is shown. More specifically, the presentation layer 20 contains a user interface 16 for a particular application 22 along with all the generated objects 30 produced by the IDL compiler, e.g., 4 from FIG. 1. The presentation layer 20 facilitates the input and editing of the objects 30, as well as validation, storage, and transfer associated a call to an API 32 with API support 34.

In one embodiment, the application of the system of the present disclosure is in a military mission context where an entity generates data, such as threat detection and handling data which is then loaded onto a system located on a platform (e.g., a land or air vehicle) where information is gathered beforehand and includes details such as possible threats the vehicle may encounter. In certain embodiments, the objects 30 include, common objects, such as session information, emitter IDs for use in assessing incoming threats, Radar Warning (RW) and High Sense (HS) information, High Gain Electronic Support Measures (HGESM) and high gain electronic, radio frequency, and expendable CM (counter measures).

In certain embodiments, when an application presentation layer 20 issues an API call, object serialization 30 occurs and the result is transferred 38 to an interface logic layer 40. This transfer can be either on the same machine or across a network. Upon receipt of the object 30 contents, the Interface layer 40 reconstructs the objects 30 utilizing controllers 44 and Electronic Warfare Mission Data Tools (EWMDT) Service 42. The objects(s) 30 are then ready for the appropriate algorithm in the Business Logic layer 60.

If the business logic layer 60 requires export generation, the Mission Data Generation Layer 80 performs that function for data 70 and produces persistent Mission Data Files 50. Results from the Business Generation Layer 80 traverses the same path in the opposite direction. The Interface Logic Layer 40 will serialize the object results and transmit 38 to the presentation layer 20. The presentation layer 20 will de-serialize the contents and reconstruct the results. Depending on user interaction, the objects 30 may be saved to persistent storage and/or displayed on the GUI. In certain embodiments, object validation occurs prior to serialization in the presentation layer 20 and API layer 32. The Presentation Layer 20 does the validation interactively so the GUI 16 may present the user with such guidance. The API layer 32 always enforces object validation to insure the transfer does not contain any errors that may violate algorithmic boundaries.

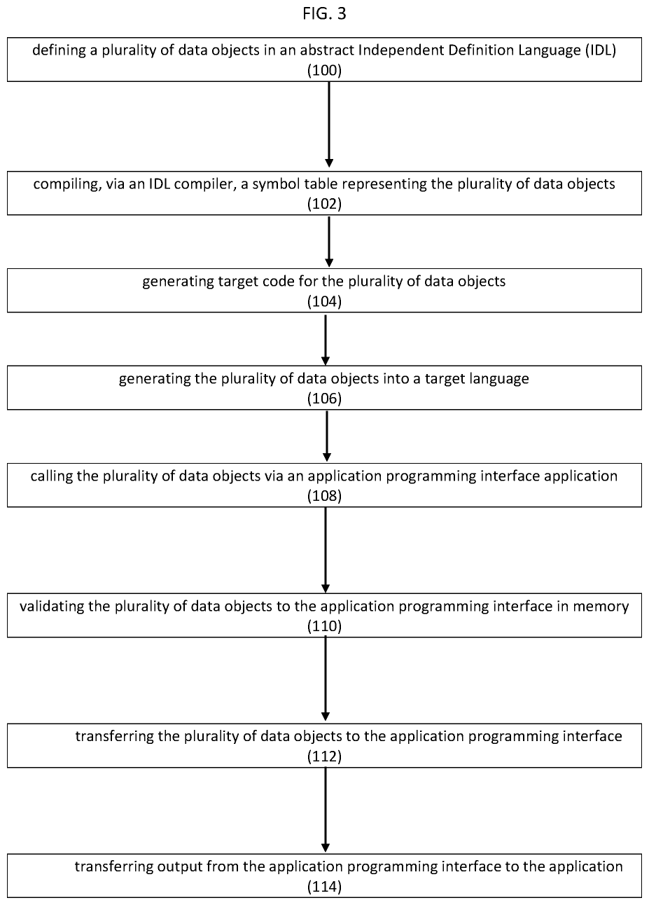

Referring to FIG. 3, a flow chart of one embodiment of a method according to the principles of the present disclosure is shown. More specifically, in one embodiment, a plurality of data objects are defined in an abstract Independent Definition Language (IDL) 100 and the plurality of data objects are stored in memory. An IDL compiler compiles a symbol table representing the plurality of data objects 102. The data objects in one example are abstractions to disparate language algorithms including legacy language computer software items. Target code is generated for the plurality of data objects 104 and the plurality of data objects are generated into a target language 106. The plurality of data objects are then called via an application programming interface from an application 108. The plurality of data objects are validated to the application programming interface in memory 110. The plurality of data objects are transferred to the application programming interface 112 and output from the application programming interface is transferred to the application 114.

In one embodiment of the present disclosure, IDL files are created and then stored to physical persistent storage. During a software build step, the Integrated Development Environment (IDE) executes a pre-build step that invokes the IDL Compiler. The IDL Compiler is read from physical storage into memory by the Operating System (OS). The IDE passes the folder locations as program arguments via the OS to the IDL compiler. Upon memory execution, the IDL Compiler will read IDL files from physical storage and build symbol information in memory on the compilation first pass. On the compilation second pass, the IDL compiler outputs target language generated files to physical storage. It will then exit processing. Upon program termination, the IDE build resumes in memory execution to load/compile/assemble the generated files and output those results onto physical storage.

During runtime, the service is loaded by the OS and executes on a CPU as an application. The service will remain dormant until the application begins execution by a user (e.g., a Mission Data Engineer). When the user starts the application, the application will connect to the service and exchange information as part of the API in memory. The user(s) will then exercise the application, which repeatedly makes API calls to the service in memory and possibly over a network until whatever is required for a mission has been created.

In certain embodiments, once a user determines mission criteria has been met, the user may command the application to build the mission which again exercises the API in memory or over a network to create mission bundles onto physical storage. The physical files are then securely transferred for further use either to test stations or to an actual mission vehicle. Either way, the files are loaded into memory from the secure transfer method for usage in that environment.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method of integration of data objects between disparate language implementations, comprising:
defining a plurality of data objects in an abstract Independent Definition Language (IDL);
storing the plurality of data objects in memory;
compiling, via an IDL compiler, a symbol table representing the plurality of data objects;
generating target code for the plurality of data objects;
generating the plurality of data objects into a target language;
calling the plurality of data objects via an application programming interface from an application;
validating the plurality of data objects to the application programming interface in memory;
transferring the plurality of data objects to the application programming interface; and
transferring output from the application programming interface to the application.

2. The method according to claim 1, wherein the generated code also contains serialization/deserialization routines needed for object transfer.

3. The method according to claim 1, wherein generating target code for the plurality of data objects includes endianness and data type differences between languages without the need for development intervention.

4. The method according to claim 1, wherein generating target code for the plurality of data objects includes data storage specifications required by Object Relational Mapping (ORM), Java Script Object Notation (JSON) or Structured Query Language (SQL).

5. The method according to claim 1, further comprising generating target code for field validation is contained in the data objects.

6. The method according to claim 1, wherein generating target code for the plurality of data objects includes transmission and documentation for use in an Interface Control Document (ICD).

7. The method according to claim 1, wherein defining a plurality of data objects includes names, types, security levels, access levels, tags for database composition, and field descriptions.

8. The method according to claim 1, wherein generating target code for the plurality of data objects includes support for abstraction and inheritance.

9. The method according to claim 2, wherein serialization is executed in memory.

10. The method according to claim 1, wherein transferring can be memory to memory or over a network.

11. The method according to claim 1, further comprising creating symbol tables in memory for use in code generation.

12. The method according to claim 11, wherein code generation is output to persistent storage and further comprises executing via a complier and using the symbol table.

13. A computer program product including one or more non-transitory machine-readable mediums encoding instructions that when executed by one or more processors cause a process to be carried out for integrating data objects, the process comprising:
defining a plurality of data objects in an abstract Independent Definition Language (IDL);
storing the plurality of data objects in memory;
compiling, via an IDL compiler, a symbol table representing the plurality of data objects;
generating target code for the plurality of data objects;
generating the plurality of data objects into a target language;
calling the plurality of data objects via an application programming interface from an application;
validating the plurality of data objects to the application programming interface in memory;
transferring the plurality of data objects to the application programming interface; and
transferring output from the application programming interface to the application.

14. The computer program product according to claim 13, wherein the data objects are directed to programming languages comprising C++, and the target code is Java and C#.

15. The computer program product according to claim 13, comprising integrating the data objects into an Object Relational Mapping (ORM).
